(19) United States
(12) Patent Application Publication
(10) Pub. No.: US 2014/0191706 A1
(43) Pub. Date: Jul. 10, 2014

(54) Article of Clothing and Related Methods

(71) Applicant: Mario Maese, El Paso, CA (US)

(72) Inventor: Mario Maese, El Paso, CA (US)

(21) Appl. No.: 14/149,784

(22) Filed: Jan. 7, 2014

Related U.S. Application Data
(60) Provisional application No. 61/750,303, filed on Jan. 8, 2013.

(51) Int. Cl. H02J 7/00

(52) U.S. Cl. CPC H02J 7/0042
USPC 320/103

(57) ABSTRACT

A device for charging portable electronic devices via a motorcycle, said device comprising: (a) a connector for a portable electronic device; and (b) said connector electrically connected to a vehicle's battery.

### CROSS-REFERENCE TO RELATED APPLICATIONS

This application claims the benefit and priority of U.S. Prov. Pat. App. Ser. No. 611750,303 (filed on Jan. 8, 2013) entitled “ARTICLE OF CLOTHING AND RELATED METHODS.” Said provisional application is hereby incorporated by reference in its entirety.

### STATEMENT REGARDING FEDERALLY SPONSORED RESEARCH OR DEVELOPMENT

Not applicable.

### BACKGROUND OF THE INVENTION

1. Field of the Disclosed Subject Matter

The present invention relates to articles of clothing. In particular, clothing for use with operation of motor vehicles, namely, vests containing power supply hookups for portable electronic devices.

2. Background of the Disclosed Subject Matter

Portable electronic devices can be used to, among other activities, make telephone calls, access the internet and other computer networks, send instant messages, take photographs or video, and provide digital entertainment (e.g., digital audio, videos, or print media). In view of the foregoing, many portable electronic device owners are desirous of the continuous availability of their device. For this reason, owners have been known to position the device on or near their person.

Sometimes, positioning a device proximate to its user's person cannot, by itself, accomplish the continuous availability of the device. This is due to power loss by the device's battery such that, over time, the device is inoperable while nevertheless being proximate to the user. As a solution, the device may be electrically coupled to an electricity outlet for charging the battery. However, such power outlets are not always conveniently located by the user, particularly while the user is operating a motor vehicle. Thus, a need exists for apparatus and related methods of charging portable electronic devices while operating a motor vehicle, and more specifically motorcycles.

Apparatus are available for connecting a portable electronic device to a power outlet of a motor vehicle. In one known example, the device is charged via coupling a charge cord to the device and the industry standard twelve-volt cigarette lighter receptacle of the motor vehicle. While suitable for automobiles, such apparatus and related methods have not been entirely satisfactory for motorcycles and like motor vehicles because: (1) motorcycles either do not have the standard 12 volt cigarette lighter receptacle; (2) motorcycles do not have a convenient location for placing the portable electronic device while charging; or (3) the charging apparatus has a long cord that can be unaesthetic or cumbersome to the operation of the motorcycle. Thus a need exists for apparatus and related methods of charging a portable electronic device while operating a motorcycle or similar motor vehicle.

Finally, many motorcycle riders are desirous of using head-worn portable electronic device while riding, but are restricted thereby the battery life of such devices. Conventional forms of charging head-worn devices are not suitable for motorcycle riders since the charging cord encumbers the riders head movements. Accordingly, a need exists for charging head worn portable electronic devices of motorcycle riders.

### SUMMARY OF THE DISCLOSED SUBJECT MATTER

In view of the forgoing, it is an objective of this specification to disclose apparatus and related method of charging a portable electronic device while operating a motorcycle or similar motor ye hide, More specifically, it is an objective of this description to disclose apparatus and related methods of charging a portable electronic device with the following attributes:

a convention location for positioning the device;
a mechanism for coupling the apparatus to the electrical system of the motorcycle; and,
wherein the apparatus is aesthetic; and,
wherein operation of the motorcycle is unencumbered by the apparatus.

In one embodiment, the disclosed apparatus is a protective vest for a rider of a vehicle, the vest comprising: at least one front pocket; at least one back pocket; a neck hole; an electrical input port coupled to internal wiring; at least one electrical connector for a portable electronic device that is (a) provided to the front pocket of the vest and (b) coupled to the internal wiring of the vest; at least one electrical connector for a portable electronic device that is (a) provided to the back pocket of the vest and (b) coupled to the internal wiring of the vest; at least one electrical connector for a portable electronic device that is (a) provided at the neck hole of the vest and (b) coupled to the internal wiring of the vest; and, a vest mater that is coupled to the internal wiring of the vest. To achieve such apparatus and related methods, the input port may preferably link the internal wiring of the vest to the power sources of a vehicle. The electrical connection between the (1) vehicle power source and (2) the vest passes preferably through the vehicle fuse box and an adapter, which is preferably used so that the fuse box of any vehicle is readily and easily connectable to the vest by and through the vest input.

In one mode of operation, (a) a portable electrical device is coupled to the connector in the front pocket of the vest plus secured in the same and (b) the input port of the vest is coupled to an electrical output from a motorcycle. In another mode of operation, (a) a portable electronic device is coupled to the connector provided to the pocket on the back of the vest plus secured therein and (b) the input port of the vest is coupled to an electrical outlet from the motorcycle. Finally, in one mode of operation, (a) a portable electronic device (such as a smart helmet or smart eyeglasses) is coupled to the connector provided at the neck hole of the vest and (b) the input port of the vest is coupled to an electrical outlet of the motorcycle.

### BRIEF DESCRIPTION OF THE DRAWINGS

The manner in which these objectives and other desirable characteristics can be obtained is explained in the following description and attached drawings in which:

FIG. 1 is a frontal view of a vest which depicts a pouch or pocket for a portable electronic device, the pouch or pocket featuring an electrical connector for the device, and an electrical input port where the vest meets with the power connection on the motorcycle;

FIG. 2 is a back view of the vest showing a pouch or pocket for a portable electronic device, an electrical connector for the device;

FIG. 3 is a side view of the vest depicted in FIGS. 1 and 2, further showing the vest's adjustable action feature, which allows fits for various rider shapes and sizes;

FIG. 4 is a front view of the vest depicting the vest's input port and the subsurface spring-coiled electrical wire attached to the port, which permits division of an electrical line,

FIG. 5 is a rear view of the vest that depicts a vest mater that may be used to connect to a separate vest;

FIG. 6 depicts two vests, as they are adapted to connect first to the power source of the vehicle and second to one another by way of the vest mater;

FIG. 7 depicts an embodiment of the present invention where the vest input port is male, the vehicle adapter is female and the ports plus adapter are coupled physically and electrically preferably in releasable locking fashion; and,

FIG. 7 also depicts the chain of electrical connection between the vehicle's power supply and the vest.

It is to be noted, however, that the appended drawings illustrate only typical embodiments of this invention and are therefore not to be considered limiting of its scope, for the invention may admit to other equally effective embodiments. Furthermore, the figures are not necessarily drawn to scale.

### DETAILED DESCRIPTION OF THE INVENTION

In general, the disclosed apparatus is a vest for charging a portable electronic device of a rider of a vehicle. Preferably, vest features: a pouch or pocket with an internal electrical connector for charging the device; an electrical input port; internal wiring; and, wherein the input port, internal wiring, and electric connector are electrically coupled in series. Ultimately, the input port may preferably link the internal wiring of the vest to the power sources of a vehicle for providing electricity through the internal wiring to the electrical connector. The connection between the (1) vehicle power to source and (2) the input port of the vest passes preferably through the vehicle fuse box and an adapter, which is preferably used so that the fuse box of any vehicle is readily and easily connectable to the vest by and through the vest input. The more specific details of this disclosure are further set forth in connection with the figures.

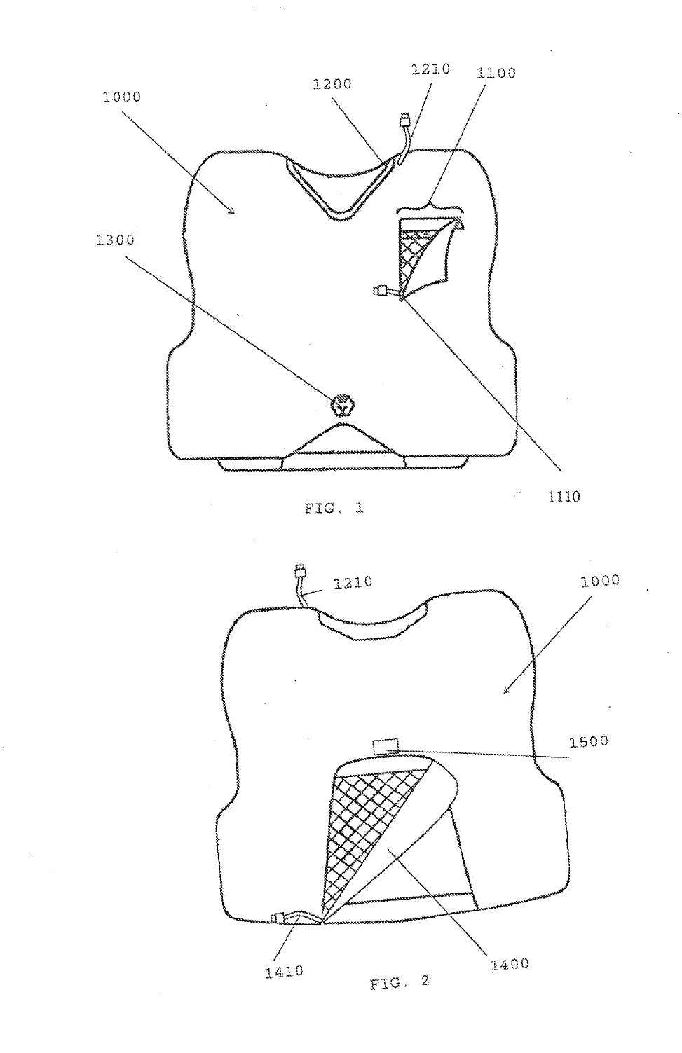

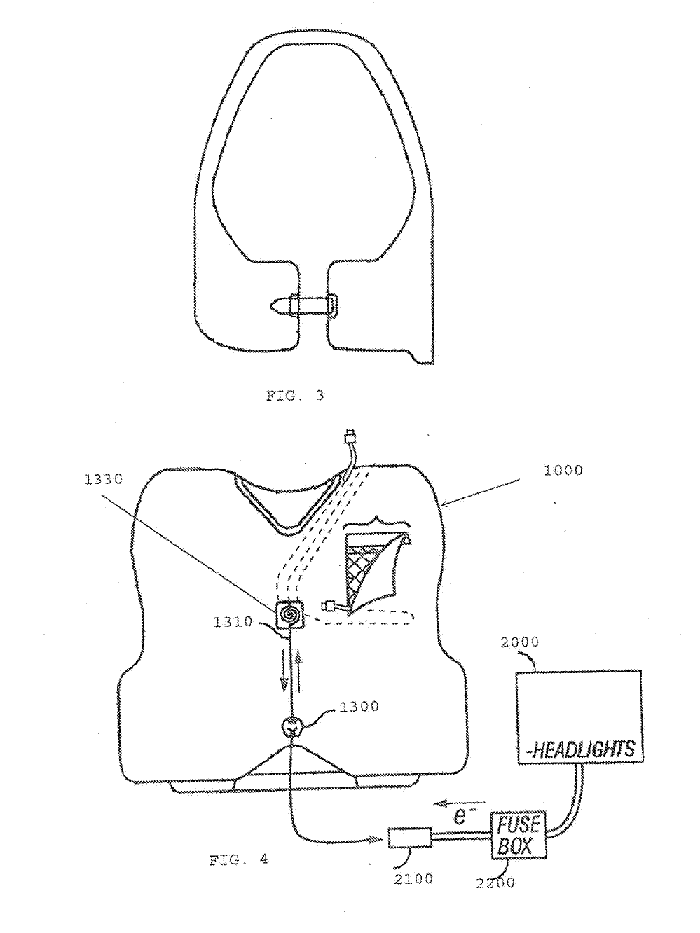

FIG. 1 is a front view of the preferred embodiment of a vest 1000, FIGS. 2 and 3 are respectively back, and side views of the vest 1000. As shown in FIGS. 1 through 3, the vest 1000 may feature: a front pocket 1100 with an electrical connector 1110; a collar or neck hole 1200 with an electrical connector 1210 provided thereto; an input port 1300 for connecting the vest 1000 to an electrical power source of a vehicle; a back pocket 1400 with an electrical connector 1410; and a vest mater 1500 for electrically connecting another vest (not shown) with the vest 1000. Preferably, the electrical connectors 1110, 1210, 1410 are keyed to a particular portable electronic device, but those of skill in the art will know well to employ other types of connectors, e.g., plug or socket connectors, terminal block connectors, post connectors, or blade connectors. In a preferred embodiment, the connectors 1110, 1210, 1410 are male or female universal serial busses (USBs). This disclosure contemplates that the connectors may also be readily removed and replaced with alternate connectors, for instance with a different type or style of connector (e.g., the USB connectors could be swapped with a firewire connector, a 30-pin dock connector or with the proprietary eight-pin lightning (trademark) connector of Apple, Inc. Those of skill in the art will know well the type of connector that may be employed with the disclosed vest 1000.

Suitably the types of portable electronic devices suitable for use in connection with the disclosed vest are many. For instance any cell phone, portable media or audio player, tablet computer, lap top computer, a helmet or glasses mounted media player, a smart helmet, or smart glasses may preferably be charged via the connectors 1110, 1210, 1410. In one embodiment, a smart cell phone, e.g., an Apple (trademark) iphone (trademark), may be coupled to the connector 1110 and provided to the pocket 1100. In another embodiment, a smart helmet or glasses (e.g., project glass by Google (trademark) (https://plus.google.com/+projectglass/posts; http://en.wikipedia.org/wiki/Project_Glass)) may be coupled to the connector 1210 and worn by the user. Finally, in another embodiment a lap top or tablet computer may be coupled to the connector 1410 and secured in the back pocket 1400. Other types of portable electronic devices may also be used with the vest 1000 without departing from the spirit and intent of this disclosure.

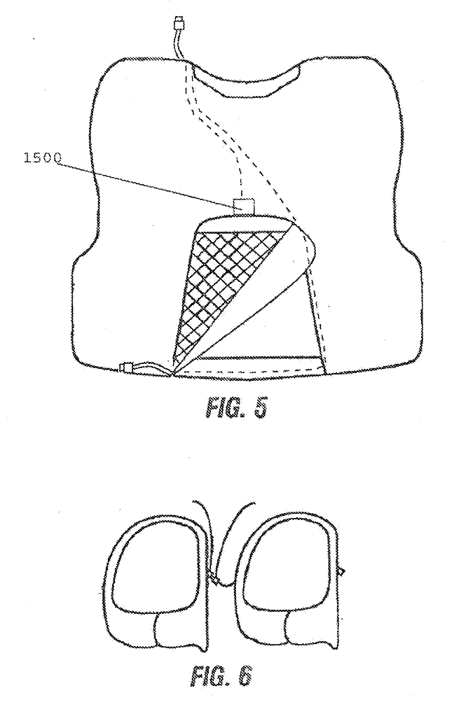

FIGS. 4 and 5 respectively depict front and back views of the vest 100 of FIGS. 1 through 3 with the internal wiring 1310 shown in dashed lines. As shown in FIG. 4, the connectors 1110, 1210, 1410 are activated by and through electrical signals communicated from the power apparatus 2000 of the rider's vehicle. The connectors 1110, 1210, 1410 are preferably connected to the vehicle's power source (power apparatus 2000) through the vest input port 1300 as depicted on FIG. 4. An electrical wire 1310 runs from the vest port 1300 to the connectors 1110, 1210, 1410 via the internal wiring 1310. Typically, this electrical wire 1310 is nonvisible from outside the vest 1000 and is concealed subsurface for purposes of style and protection from the elements. The electrical wire 1310 runs to the connectors 1110, 1210, 1410. Still referring to FIG. 4, the concealed electrical wire 1310, which is typically housed through a spring coiled mechanism 1330 for allowing the vest input port 1300 and electrical wire 1310 to be withdrawn into the vest when not in use and not connected to the rider's vehicle. The electrical wire 1310 is preferably also weatherproofed by virtue of coatings of plastic or rubber material that are waterproof. The electrical wire 1310 and vest port 1300 are designed to extend from the vest and to connect to a vehicle adapter 2100 that conveys electrical signals from the vehicle's fuse box 2200, which is in turn fed by electrical signals from the vehicle's signaling apparatus 2000, for instance, blinkers headlights. The originating electrical source is the vehicle battery and alternate sources that power the vehicle.

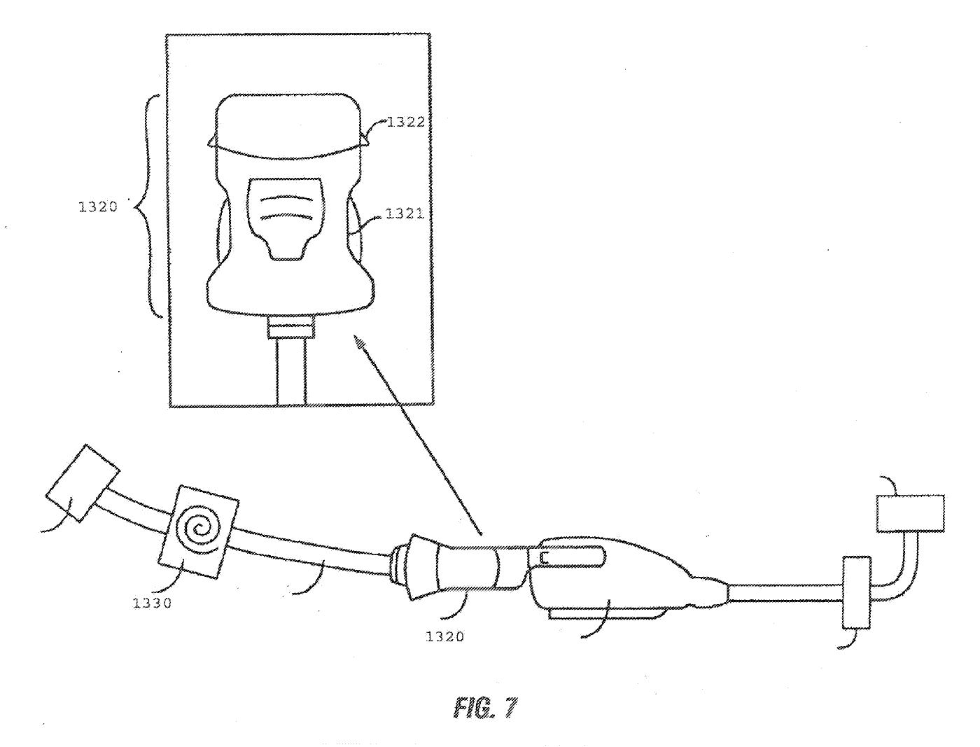

FIG. 7 is a detailed depiction of one preferable coupling of the vehicle adapter 2100 and vest port 1300. This figure shows how the vest input port 1300 is preferably “male” and designed to insert into the vehicle adapter 2100 and become locked into place to maintain physical and electrical connection. As shown in FIG. 7, the locking means 1320 is preferably releasable by the operator by depressing release buttons 1321 which cause the locking catch 1322 to engage or release from the vehicle adapter 2100. Preferably, this connection between the vehicle adapter 2100 and vest input port 1300 enjoys a “break away” feature that is activated by force that would throw a rider from the vehicle upon unintentional dismount. The female vehicle adapter 2100 would typically be fixedly connected to a lower portion of a motorcycle gas tank, for instance by the seat, where it would be conveniently accessed by a vest-wearing rider and the male vest input port 1300, which unwinds from the vest, and specifically the spring coiled mechanism 1330 The vehicle adapter 2100 is preferably connected by adhesive means to a convenient location on the vehicle accessible to the vest-wearing rider.

Referring now to FIG. 5 the back of the vest 1000 features a vest mater 1500 that permits a second rider, with a similar safety vest to “plug in” to the first rider's vest and benefit from the charging functionality of the vest 1000 described herein. The vest port 1300 of any vest 1000 is preferably adapted to connect to the vest mater 1500 of another rider's vest 1000. A releasable locking means as shown in FIG. 7 would preferably make such connection between vest port 1300 and vest mater 1500. Preferably, accidental dismount force of a rider(s) would also trigger a break-away functionality between the vest port 1300 and vest mater 1500.

FIG. 6 also depicts how two separate vests may be coupled together and “feed” from the same power and signaling source, thus producing harmonious visual signals of vehicle operator intentions. In this way, the back pocket may be used to charge an electronic device, e.g., a tablet computer, or connect a tandem riders vest to the electricity of the motorcycle.

The vest is a safety benefit to the rider because of the manner in which it enhances riders accessibility to his or her portable electronic device. In essence, the invention more permits the charging of the device while traveling and, in some case, the use of a head worn portable electronic device. For instance, when the rider desires to charge a head worn device while riding coupling the electronic device to the connector 1210 will receive electrical impulse from the vehicle's powering apparatus 2000 through the vehicle's fuse box 2200, which will in turn be conveyed to the vehicle adapter 2100, through the coupled vehicle port 1300, through the electrical wire 1310 and then through the connector 1410. The vest operates by similar mechanisms for activating the front and back pockets of the vest, except the connectors 1110 and 1410 are activated. It is contemplated that all or none of the charging ports can be used at once.

While it is contemplated that the vest 1000 and the vehicle's powering apparatus 2000 will communicate by and through electrical wires that connect the vehicle to the vest 1000, it is also preferable and contemplated that the electricity conveyed through the vehicle's power apparatus 2000 (head lights) may also be conveyed from either the vehicle's fuse box 2200 or by a battery source of the vehicle

Other notable preferable features of the present invention include the design of the pockets 1100 and 1400. Suitably said pockets are preferably made of net or other expandable cloth or cloth material, that will be useful for holding personal use items, e.g., MP3 players, radios, cell phones, wallets, etc., in addition to portable electronic devices. A corresponding hole in immediate proximity of the device pouch will permit a wire from any such devices to extend up and through the vest to the rider's ear, mouth or other suitable orifice. Another preferable feature of the present invention is adjustable actions as shown in FIG. 3, which allow the user of the vest to expand or contract the vest with personal needs. The device is designed using this feature to fit around and adjust to all body types and sizes, and also adapted to fit over clothing, even heavy jackets. The vest may expand preferably by way of adjustable buckles, adjustable Velcro devices or adjustable snap actions.

It is to be noted, however, that the appended drawings illustrate only typical embodiments of this invention and are therefore not to be considered limiting of its scope, for the invention may admit to other equally effective embodiments. For instance, the invention can be applied to any article of clothing, including shirts, jackets, coats, and the like without departing from the spirit and the intent of this disclosure.

The subject matter of this application maybe directed to a device for charging portable electronic devices via a motorcycle, said device comprising:

(a) a connector for a portable electronic device; and
(b) said connector electrically connected to a vehicle's battery.
The subject matter may further be directed to said device wherein the electrical connector is located in a pocket of the vest, wherein the electrical connector is proximate to the neck hole of the vest, wherein the portable electronic device is worn on the head of a person, and herein the portable electronic device defines eyeglasses.

The subject matter of this application maybe directed to a method of charging a portable electronic device comprising the steps of:
a. obtaining a vest;
b. adorning said vest for riding a motorcycle;
c. coupling a device to an electrical connector of the vest; an
d. coupling a port of the vest with a power source of the motorcycle.

The subject matter may further be directed to said method, wherein the electrical connector is located in a pocket of the vest, wherein the electrical connector is proximate to the neck hole of the vest, wherein the portable electronic device is worn on the head of a person, and wherein the portable electronic device defines eyeglasses.

I claim:

1. An article of clothing for charging portable electronic devices via a motorcycle, said device comprising:
(a) a connector for a portable electronic device; and
(b) said connector electrically connected to a battery of an automotive vehicle.

2. The article of clothing of claim 1 further comprising a pocket, and wherein the electrical connector is located in a pocket of the article of clothing.

3. The article of clothing of claim wherein the article of clothing is a vest.

4. The article of clothing of claim wherein said electrical connector is proximate to a neck hole of the vest.

5. The article of clothing of claim 4 wherein the portable electronic device is worn on the head of a person.

6. The article of clothing of claim 5 wherein the portable electronic device defines eyeglasses.

7. The article of clothing of claim 2 wherein the electronic device is a media player.

8. The article of clothing of claim 2 wherein the electronic device is a cellular phone.

9. The article of clothing of claim wherein the automotive vehicle is a motorcycle.

10. A method of charging a portable electronic device comprising the steps of:
a. obtaining an article of clothing;
b. adorning said article of clothing and operating an automotive vehicle;
c. coupling the portable electronic device to an electrical. connector of the article of clothing; and,
d. coupling a port of the article of clothing with an electrical power source of the automotive vehicle so that an electrical connection is established between the motorcycle and the portable electronic device.

11. The method of claim 10 wherein the article of clothing further comprises a pocket, and wherein the electrical connector is located in a pocket of the article of clothing.

12. The method of claim 11 wherein the article of clothing is a vest

13. The method of claim 12 wherein the article of clothing is a vest and said electrical connector is proximate to a neck hole of the vest.

14. The method of claim 13 wherein the portable electronic device is worn on the heat of a person.

15. The method of claim 14 wherein the portable electronic device defines eyeglasses.

16. The method of claim 15 wherein the electronic device is a media player.

17. The method of claim 11 wherein the electronic device is a cellular phone.

18. The method of claim 17 wherein the automotive vehicle is a motorcycle.

19. An article of clothing for charging a portable electronic device while operating an auto votive vehicle, said article of clothing comprising:
internal wiring for electrically coupling (i) an electronic connector connection to the portable electronic device and (ii) an input port for connection to a power supply of the automotive Vehicle.

20. The article of clothing of claim 19 wherein the auto motive vehicle is a motor cycle.
